(19) United States
(12) Patent Application Publication
(10) Pub. No.: US 2020/0175817 A1
(43) Pub. Date: Jun. 4, 2020

(54) GAMING APPARATUS AND GAME CONTROL METHOD

(71) Applicant: SEGA SAMMY CREATION INC., Yokohama-shi ,Kanagawa (JP)

(72) Inventor: Shunichi Fujita, Tokyo (JP)

(21) Appl. No.: 16/081,603

(22) PCT Filed: Mar. 2, 2016
(86) PCT No.: PCT/JP2016/056362

§ 371 Date: Aug. 31, 2018

(51) Int. Cl. G07F 17/32

(52) U.S. Cl. CPC G07F 17/3267; G07F 17/3262; G07F 17/3213; G07F 17/3244

(57) ABSTRACT

A gaming apparatus comprises a control unit, and a display unit. In a first game, the control unit changes display of the display unit by sequentially displaying a first symbol on the display unit, and stops the changing of display at a predetermined timing. In a second game, the control unit changes display of the display unit by sequentially displaying a second symbol on the display unit, and stops the changing of display at a predetermined timing, after the first symbol has been displayed at the time of the stop of display changing in the first game. The control unit grants a bonus on condition that a position where the first symbol is displayed in the first game and a position where the second symbol is displayed in the second game have a predetermined positional relationship. The gaming apparatus can provide a technique relating to a game with more fun.

### CROSS-REFERENCE TO RELATED APPLICATIONS

This application is the U.S. national phase of the International Patent Application No. PCT/JP2016/056362 filed Mar. 2, 2016, the entire content of which is incorporated herein by reference.

### TECHNICAL FIELD

The present disclosure relates to a gaming apparatus and a game control method.

### BACKGROUND

In recent years, a variety of gaming apparatuses have been developed. For example, Japanese Patent Publication JP 2015-024139 A discloses a gaming apparatus capable of playing a slot game by displaying part of virtual reels on a display unit and spinning the reels by means of computer control. In such a slot game, the gaming apparatus spins a plurality of reels in accordance with an operation of a player, sequentially stops the reels, and displays, on the display unit, a combination of symbols on the reels. Then, the gaming apparatus grants the player a bonus on the basis of the types and locations of the symbols displayed on the display unit.

### SUMMARY

The fun of a game is keen interest for a player. The fun of a game considerably varies depending upon on what conditions a bonus is granted.

With the foregoing in view, it is an object of the present disclosure to provide a technique relating to a game with more fun.

A gaming apparatus according to the present disclosure comprises: a control unit; and a display unit, wherein the control unit has: a function of, in a first game, changing display of the display unit by sequentially displaying a first symbol on the display unit, and stopping the changing of display at a predetermined timing; a function of, in a second game, changing display of the display unit by sequentially displaying a second symbol on the display unit, and stopping the changing of display at a predetermined timing, after the first symbol has been displayed at the time of the stop in the first game; and a function of granting a bonus on a condition that a position where the first symbol is displayed at the time of the stop in the first game and a position where the second symbol is displayed at the time of the stop in the second game have a predetermined positional relationship.

A game control method according to the present disclosure is implemented by a computer that comprises a control unit, and a display unit, the game control method causing the control unit to execute: a step of in a first game, changing display of the display unit by sequentially displaying a first symbol on the display unit, and stopping the changing of display at a predetermined timing; a step of, in a second game, changing display of the display unit by sequentially displaying a second symbol on the display unit, and stopping the changing of display at a predetermined timing, after the first symbol has been displayed at the time of the stop in the first game; and a step of granting a bonus on a condition that a position where the first symbol is displayed at the time of the stop in the first game and a position where the second symbol is displayed at the time of the stop in the second game have a predetermined positional relationship.

In accordance with the present disclosure, a technique relating to a game with more fun can be provided.

### BRIEF DESCRIPTION OF DRAWINGS

Various embodiments of the disclosure are illustrated in the drawings, in which:

FIG. 1 is a perspective view of the external appearance of a gaming apparatus in an embodiment.

FIG. 2 is a block diagram of the configuration of major hardware components of the gaming apparatus in the embodiment.

FIG. 3 schematically illustrates an example of a screen displayed on display devices in the embodiment.

FIG. 4 is a block diagram of the configuration of major functional components of the gaming apparatus in the embodiment.

FIG. 5 schematically illustrates an example of a screen displayed on the display devices in the embodiment.

FIG. 6 is a flowchart for explaining the processing performed by the gaming apparatus in the embodiment.

### DETAILED DESCRIPTION

Hereafter, an embodiment of the present disclosure is described with reference to the drawings. It should be noted that the embodiment described below is merely an example, and does not intend to eliminate various modifications and applications of techniques that are not explicitly indicated below. That is to say, the present disclosure can be carried out by making various modifications (such as combining examples) without departing from the spirit of the disclosure. In the drawings, identical or similar parts are assigned identical or similar reference signs. The drawings, which are schematic, do not necessarily agree with an actual measurement, dimensional ratio, or the like. The drawings can include a part having dimensional relationship and ratio that are different among the drawings.

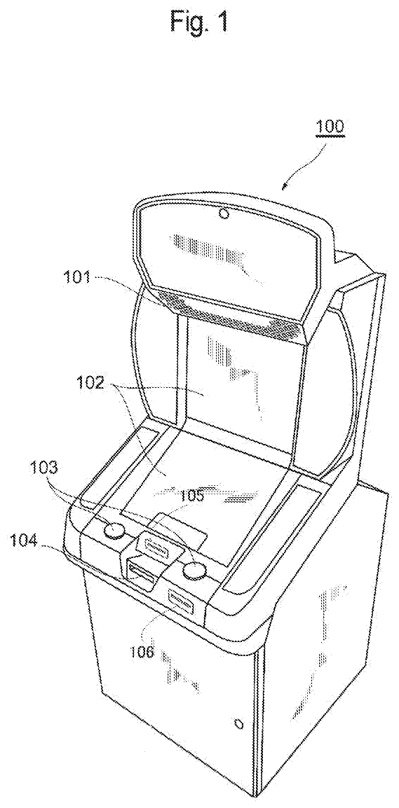

Hereafter, a gaming apparatus and a program in the embodiment of the present disclosure are explained by using the drawings. FIG. 1 is a perspective view of the external appearance of a gaming apparatus in the embodiment.

A gaming apparatus 100 shown in FIG. 1 is a gaming apparatus that is installed in a casino, amusement facility, or the like. In the embodiment, a player can play a slot game with the gaming apparatus 100.

### Example of Hardware Configuration of Gaming Apparatus

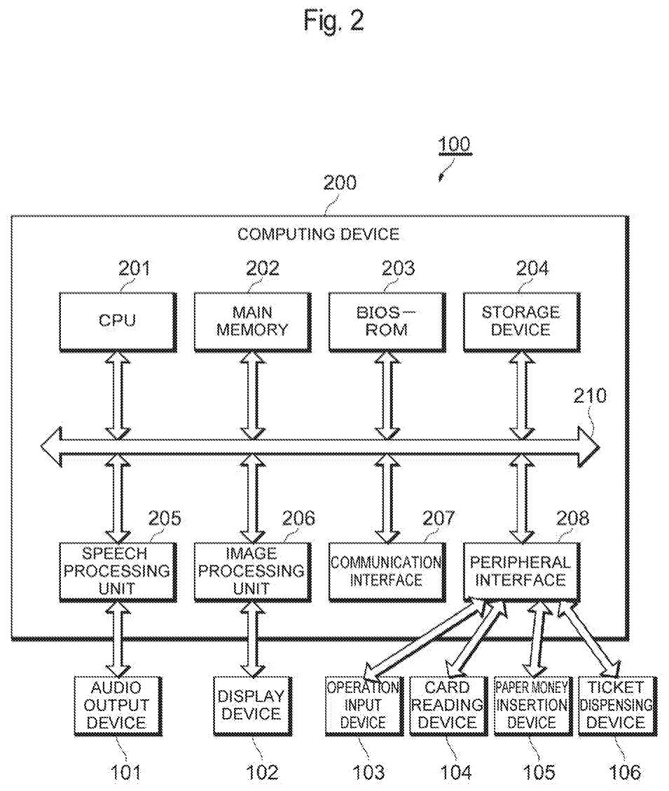

An example of the hardware configuration of the gaming apparatus 100 is described with reference to FIG. 1 and FIG. 2. As shown in FIG. 1, the gaming apparatus 100 comprises, in an external appearance thereof, a speaker 101, a plurality of display devices 102, a plurality of operation buttons (hereafter referred to as an “operation input device” 103), a card reading device 104, a paper money insertion device 105, and a ticket dispensing device 106. The speaker 101 is an audio output means for outputting sound such as speech guidance and sound effects. The display devices 102 are formed of two display devices vertically disposed, and are display means for displaying an image (for example, a still image, a moving image, a video, etc.) for expressing or rendering impressive a game. The operation input device 103 is formed of a plurality of buttons, which allow the player to input therewith instructions to the gaming apparatus. It is noted that the operation input device 103 is not limited to such a configuration; any configuration that allows the player to input instructions therewith can be selected. The card reading device 104 is a card reader that reads information from a card held by the player. The paper money insertion device 105 is a reading device that reads paper money or a ticket that has been inserted thereinto. The ticket dispensing device 106 is a ticket outputting means for dispensing cards to the player.

The card that is read by the card reading device 104 is a medium in which game-playing information of the player is stored. The card is capable of additionally storing of, for example, points acquired in accordance with game-playing status of the player, or the like. The player is given various services in accordance with information stored in the card, whereas information stored in the card does not influence game results.

As shown in FIG. 2, the gaming apparatus 100 comprises, as the hardware configuration, a computing device 200, an audio output device 101, the display devices 102, the operation input device 103, and the card reading device 104, the paper money insertion device 105, and the ticket dispensing device 106.

The computing device 200 is a control device that controls the entire gaming apparatus 100. The computing device 200, which is composed of various processors, memories, etc., is a computer circuit element comprising, for example, a chipset. The computing device 200 according to the present embodiment comprises, for example, a CPU 201, a main memory 202, a BIOS-ROM 203, a storage device 204, a speech processing unit 205, an image processing unit 206, a communication interface 207, a peripheral interface 208, and a system bus 210 for connecting among these components.

The CPU 201 executes, for example, a gaming program expanded on the main memory 202 to make the computing device 200 fulfill various functions. In other words, the computing device 200, under the control of the CPU 201, implements a game in cooperation with the other hardware by executing the gaming program.

The storage device 204 stores various programs and data as data required in processing in the computing device 200 and results of the processing. The speech processing unit 205 performs various sound processes under the control of the CPU 201. The image processing unit 206 performs various graphics processes under the control of the CPU 201. The communication interface 207 is an interface that allows communication therethrough with a server or another gaming apparatus. The peripheral interface 208 is an interface that allows communication therethrough with peripheral equipment comprising the operation input device 103, the card reading device 104, the paper money insertion device 105, and the ticket dispensing device 106.

### Example of Game Contents

Next, an example of game contents is described that a user can play with the gaming apparatus 100 according to the present embodiment. The gaming apparatus 100, under the control of the CPU 201, expands and executes, on the main memory 202, the gaming program stored in the storage device 204 or the like to control various components of the gaming apparatus 100; as a result, this game is implemented.

First, to start the game, the player inserts a held card into the card reading device 104 of the gaming apparatus 100, and/or a coin into the paper money insertion device 105. Once the card or the coin is inserted, the player possesses a card balance or a credit corresponding to the coin in the game.

Then, the gaming apparatus 100 displays, on the display devices 102, a bet screen for allowing thereon the player to bet on a slot game. In accordance with instructions from the player for betting and starting, the gaming apparatus 100 starts a game of slot game. A game that is playable by inputting a coin or the like, that is, paying money, as above, is referred to as a “normal game” in the description below. Meanwhile, a game that is playable free of charge, that is, without paying money is referred to as a “free game” in the description below. In a normal game or a free game, first, the gaming apparatus 100 spins a plurality of virtual reels (for example, five reels; hereafter, the virtual reels are also referred to simply as “reels”), and stops the spin of the reels at a random timing for each reel. After the stop, a part of each reel is displayed on the display devices 102.

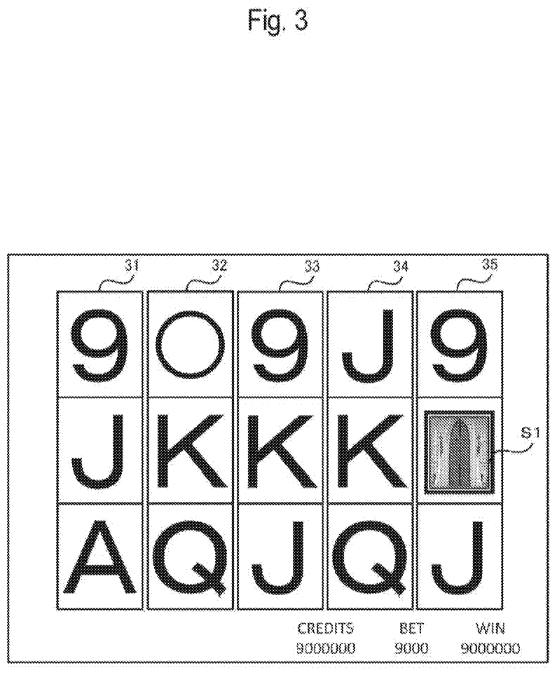

FIG. 3 shows display of symbols (graphic symbols) shown in a part of each reel after the spinning of the reels have been stopped, as an example of display of the display devices 102. In this example, the display devices 102 show five reels 31 to 35, and display three symbols on each reel. In accordance with whether the alignments of symbols displayed on the display devices 102 in this way are in conformance with a line (payline) that is set (or selected) in advance, the player is granted various bonuses. In addition, when a predetermined symbol (for example, a wild symbol) has been located in accordance with a predetermined condition (an example of the condition is described later), as well, the player is granted various bonuses. Although a bonus is not particularly limited, a credit or a free game, for example, is granted as a bonus. In addition, bonuses having various values are set for a big win to a small win in accordance with the locations or types of displayed symbols. For example, the less probable the alignment of identical symbols in conformance with a payline, the bigger the win. Such an alignment can be granted a high credit. Hereafter, the free game will be further described.

When, in a normal game, the locations and types of symbols displayed on the display devices 102 at the time of the stop of the reel spin have met a predetermined condition, the gaming apparatus 100 transitions to a state that allows the free game to be played. That is to say, when the locations and types of displayed symbols have met the predetermined condition, the player is granted a right to play a free game. The predetermined condition is described later. Then, the player is allowed to play the free game a predetermined number of times (for example, ten times) successively. In the free game, as well, in accordance with the alignments of symbols or the location of a predetermined symbol after the stop of the reel spin, the player is granted various bonuses such as a credit and a retrigger. In this regard, the retrigger is a bonus that allows the player to further play the free game a predetermined number of times (for example, ten times).

Upon completion of the playing of all of the free games, the gaming apparatus 100 transitions again to a state that allows the normal game to be played. It is noted that the unit of a game is defined as corresponding to the period of time from the time when instructions from the player for starting are enabled to the time when it is determined whether a bonus is granted in accordance with the stop positions of the reels. After it has been determined whether a bonus is granted in a first game, the player is allowed to make instructions for betting or starting for a second game succeeding the first game.

### Example of Functional Configuration of Gaming Apparatus

Next, an example of the functional configuration of the gaming apparatus 100 according to the present embodiment is described.

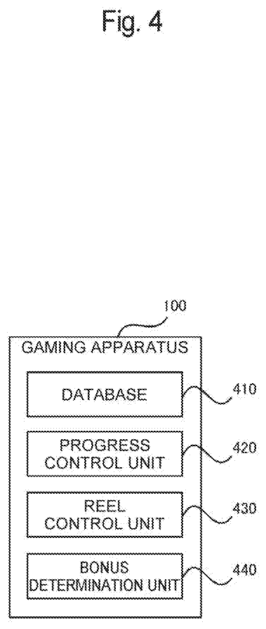

FIG. 4 is a block diagram showing the functional configuration of the gaming apparatus 100 according to the present embodiment. As shown in the figure, the gaming apparatus 100 mainly comprises, as the functional configuration, a database 410, a progress control unit 420, a reel control unit 430, and a bonus determination unit 440. The functional configuration is fulfilled in the cooperation between a program (software) and hardware included in the gaming apparatus 100; the CPU 201, for example, expands and executes, on the main memory 202, the gaming program stored in the storage device 204 to fulfill the functional configuration. It is noted that the gaming apparatus 100 has, in addition to the functions shown in FIG. 4, other functions that typical gaming apparatuses have; however, description therefor is omitted now.

The database 410 stores various types of information comprising information required in processing performed in the gaming apparatus 100, and information created as a result of the processing. The database 410 stores, for example, a control program for controlling the progress of a game, image (for example, a still image, a moving image, a video, etc.) data and sound data for expressing or rendering impressive the game, and data related to the state of the game under progress.

The progress control unit 420 performs processing for controlling the progress of the game in accordance with operations on the gaming apparatus 100 by the player of the game, and the control program stored in the database 410. In particular, the progress control unit 420 controls the progress of the normal game of slot game as described above, the switching from the normal game to the free game, the progress of the free game, and the switching from the free game to the normal game. For example, when, in the normal game, symbols displayed on the display devices 102 after the stop of the reel spin meet a predetermined condition, the progress control unit 420 performs control to cause a transition to the state that allows the free game to be played, or to grant the player a right to play a free game at a desired timing. Upon the transition to the state that allows the free game to be played, the progress control unit 420 performs control to execute the free game a predetermined number of times (for example, ten times) successively. In this regard, granting the player the right to play a free game specifically corresponds to, for example, the operation wherein the progress control unit 420 stores, in the database 410, data indicating that a player to be granted the right is allowed to play a free game. Then, the progress control unit 420 refers to the database 410 to determine whether the player to be granted the right is allowed to play a free game, and in a case where the player is allowed to, controls the play of the free game. In addition, the control of the progress control unit 420 as above is made in accordance with results of processing by the reel control unit 430 and the bonus determination unit 440, both described later.

The reel control unit 430 controls the spin and stop of the reels in a slot game, and the display of a picture of the reels on the display devices 102. A plurality of symbols are shown on the surfaces of the reels, and the reel control unit 430 performs control to display a part of the plurality of symbols on the display devices 102. While the reels spin, the reel control unit 430 sequentially changes display of the display devices 102 by displaying, on the display devices, symbols that have shown at positions according to the spin among the plurality of symbols shown on the reels, while sequentially scrolling to the symbols. Then, the reel control unit 430 performs control to stop the scroll of the display by stopping the spin of the reels at a predetermined timing. In an example shown in FIG. 3, the reel control unit 430 controls the spin and stop of each of the five reels. In addition, in FIG. 3, among the plurality of symbols shown on one reel, three symbols are displayed on the display devices 102. Accordingly, in this example, a total of 15 symbols among the plurality of symbols shown on the five reels are displayed on the display devices 102.

In addition, in the present embodiment, the reel control unit 430 is capable of performing control so that at least a part of the plurality of symbols shown on the reels differs for each game. For example, the symbols on the reels can be changed for each game, as below.

First, the reel control unit 430, in a game (a first game), performs control to spin reels having surfaces on which a plurality of symbols comprising a first symbol are shown, and display the first symbol on the display devices 102 while sequentially scrolling to the first symbol at a predetermined timing in accordance with positions of the surfaces of the reels that change due to the spin (that is to say, sequentially changing display of the display devices 102). Then, the reel control unit 430 stops the spin of the reels at a predetermined timing to stop the scroll display of the symbols.

In a case where the first symbol is displayed on the display devices 102 at the time of the stop of the scroll in the first game, the reel control unit 430, in a succeeding game (a second game), spins reels on which a second symbol is shown. In accordance with positions of the surfaces of the reels that change due to the spin, the reel control unit 430 performs control to display the second symbol on the display devices 102 while sequentially scrolling to the second symbol at a predetermined timing (that is to say, sequentially changing display of the display devices 102). The reel control unit 430 performs control to stop the spin of the reels at a predetermined timing to stop the scroll display of the symbols. Meanwhile, in the second game, the reel control unit 430 performs control to indicate, on the display devices 102, the stop position of the first symbol in the first game.

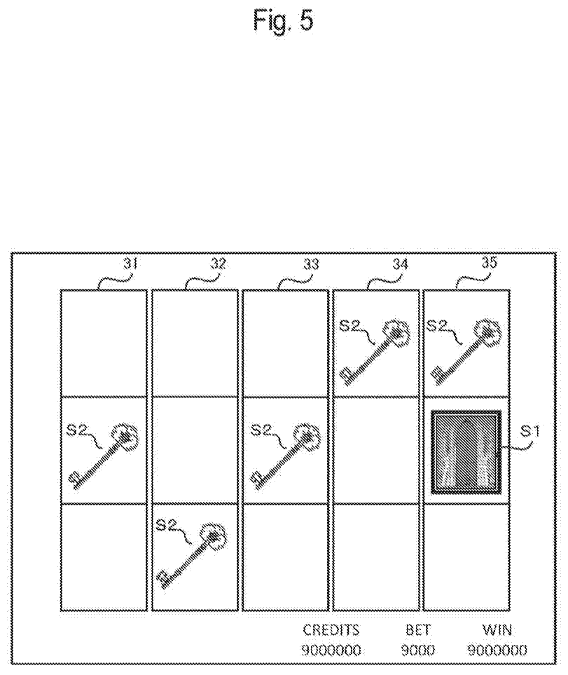

With reference to FIG. 3 and FIG. 5, examples of screens displayed on the display devices 102 in the first game and the second game are described.

FIG. 3 shows a screen displayed on the display devices 102 when the scroll display has been stopped in the first game. It is noted that symbol S1 is the first symbol.

FIG. 5 shows an example of a screen displayed on the display devices 102 at the time of starting the second game (this may be at the time of reel spin or at the time of reel stop after the spin start) when the first game has ended in the state shown in FIG. 3. Symbol S2 is the second symbol. The symbol S2 is shown at predetermined intervals on each of the surfaces of the reels 31 to 35. In addition, the symbol S2 (the second symbol) is not shown on the reels in the first game. That is to say, at least a part of a plurality of symbols shown on the reels is different between the first game and the second game.

In addition, in the example shown in FIG. 5, the symbol S1 (the first symbol) is displayed at the position where the symbol S1 was stopped in the first game. That is to say, the stop position of the first symbol in the first game is indicated by the first symbol in the second game. The symbol S1 shown in the second game indicates the stop position of the first symbol in the first game, and the position where the symbol S1 is displayed is not changed even though the spin of the reels is started in the second game. It is noted that, to indicate the stop position of the first symbol in the first game, the first symbol in the second game may be displayed in a translucent manner, in a blinking manner, in a manner such that the scale is reduced, or in a manner such that the form is modified.

Furthermore, symbols shown on the reels in the example of FIG. 5 (i.e., symbols that are displayed in the second game) are symbols S2 (the second symbol) alone, apart from the symbol (the symbol S1) for indicating the stop position of the first symbol in the first game. However, the display shown in the FIG. 5 is merely an example. In the second game, reels on which one or a plurality of types of symbols in addition to the second symbol are shown may be spun and displayed on the display devices 102.

Description returns to the explanation of FIG. 4. The bonus determination unit 440 determines a bonus in accordance with the locations of symbols displayed on the display devices 102 after the scroll of symbol display (the spin of the reels) is stopped, and grants the player the bonus.

For example, the bonus determination unit 440 is capable of determining a bonus to be granted, in accordance with whether the alignments of symbols are in conformance with a line (payline) that is set or selected in advance. Although a bonus is not particularly limited, a credit, a raised payout (a raised amount of payout or a raised payout rate), or a right to play a free game, for example, is granted.

In addition, the bonus determination unit 440 is capable of granting a bonus on the basis of a symbol location condition set across a plurality of games. For example, the bonus determination unit 440 is capable of granting the player a bonus on the condition that the stop position of a predetermined symbol in the first game and the stop position of a predetermined symbol in the second game played after the first game have a predetermined positional relationship. As a specific example, the bonus determination unit 440 is capable of granting the player a right to play a free game as a bonus when the stop position of the first symbol in the first game and the stop position of the second symbol in the second game have coincided with each other (or have been adjacent to each other).

In the example shown in FIG. 5, the bonus determination unit 440 is capable of granting the player a right to play a free game as a bonus when a position indicating the stop position of the symbol S1 (the first symbol) in the first game and a position where the symbol S2 (the second symbol) has been stopped in the second game have coincided with each other (or have been adjacent to each other). It is noted that, in this example, the symbol S1 has the form of a door, and the symbol S2 has the form of a key. Thus the two symbols have forms conceptionally associated with each other (that is to say, a “door” is opened by using a “key”). The first symbol and the second symbol can have forms having some or no association with each other in other manners.

In addition, the bonus determination unit 440 is capable of determining a bonus to be granted, in accordance with the type of the first symbol that has a predetermined positional relationship to the second symbol. For example, suppose that a plurality of types of first symbols that have the form of a door but have different forms and/or colors are present. Here, the bonus determination unit 440 is capable of determining the type of a free game for which the right to play is granted, in accordance with, for example, the type of a first symbol that has a predetermined positional relationship to the second symbol.

Furthermore, the bonus determination unit 440 is capable of determining a bonus in accordance with the type of the second symbol that has a predetermined positional relationship to the first symbol. For example, suppose that a plurality of types of second symbols that have the form of a key but have different forms and/or colors are present. Here, the bonus determination unit 440 is capable of determining the type of a free game for which the right to play is granted, in accordance with, for example, the type of a second symbol that has a predetermined positional relationship to the first symbol.

It is noted that, by combining the examples above, the bonus determination unit 440 is capable of determining the type of a free game for which the right to play is granted (i.e., the type of a bonus) on the basis of a combination of the types of first and second symbols that have a predetermined positional relationship.

As described, in accordance with the present embodiment, the reel control unit 430, in the first game, displays the first symbol on the display devices 102 while sequentially scrolling to the first symbol at a predetermined timing, and stops the scroll of display at a predetermined timing. In a case where the first symbol is displayed when the scroll is stopped in the first game, the reel control unit 430, in the second game, displays the second symbol on the display devices 102 while sequentially scrolling to the second symbol at a predetermined timing, and stops the scroll of display at a predetermined timing. The bonus determination unit 440 grants a right to play a free game on the condition that the stop position of the first symbol in the first game and the stop position of the second symbol in the second game have a predetermined positional relationship.

Thus, in accordance with the present embodiment, a game with more fun is provided than a conventional game in which the player is granted a bonus in accordance with the positional relationship of symbols displayed when the reels have been stopped, in a single game alone. That is to say, the player hopes that, in the first game, the first symbol will be displayed after the reels have been stopped. In addition, when the first symbol is displayed in the first game, the player hopes that, in the second game, the second symbol will be displayed after the reels have been stopped. This results in gradually raising the hope of the player for a bonus over a plurality of games. Thus, a game with more fun is provided.

### Flow of Processing

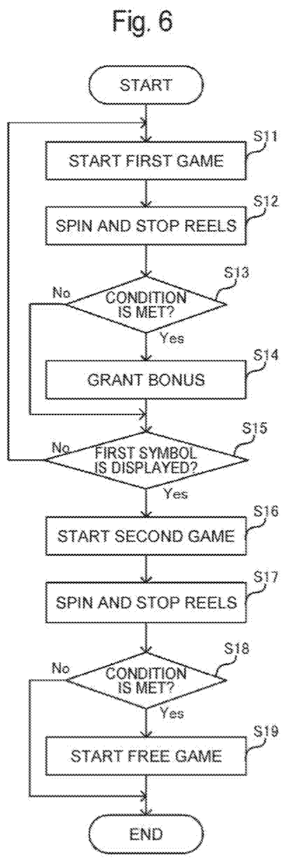

Next, with reference to FIG. 6, the flow of processing performed in the gaming apparatus 100 is described. The processing is performed in the cooperation between a program (software) and hardware included in the gaming apparatus 100; for example, the CPU 201 as a control unit expands and executes, on the main memory 202, a program stored in the storage device 204 or the like to perform the processing. It is noted that processing steps included in the flow of processing described below can be changed in an arbitrary order or performed in a parallel manner to an extent that does not result in inconsistency among the processing. In addition, other steps can be added between the processing steps to an extent that does not result in inconsistency among the processing. In addition, a step indicated for convenience sake as a single step can be divided into a plurality of steps and performed, while steps indicated for convenience sake in the form of a plurality of divided steps can be regarded as a single step. It is noted that details of each processing step have been already described with reference to FIG. 4, etc., and thus are omitted now.

First, in step S11, the CPU 201 starts executing the first game of slot game in accordance with insertion of a bet for the game and operation instructions made by the player to the gaming apparatus 100, and proceeds with the game. The processing continues to step S12. It is noted that the first game may be a normal game or a free game. When it is a free game, the insertion of a bet is not required to start the game.

In step S12, the CPU 201 performs control to spin a plurality of reels (for example, five reels), and display, on the display devices 102, a picture of the reels as captured when the spin has been stopped at a predetermined timing. A plurality of symbols comprising the first symbol are shown on each reel. While the reels spin, the CPU 201 performs control to display, on the display devices 102, symbols that have shown at positions according to the spin among the plurality of symbols shown on the reels, while sequentially scrolling to the symbols, and stop the scroll of display at a predetermined timing. Then, the processing continues to step S13.

In step S13, the CPU 201 determines whether the locations of symbols displayed on the display devices 102 after the scroll of symbol display (the spin of the reels) is stopped meet a condition that is set in advance for granting a bonus (for example, the alignments of a plurality of symbols are in conformance with a payline that is set or selected in advance). When the condition is met (Yes), the processing continues to step S14, and when the condition is not met (No), the processing continues to step S15.

In step S14, the CPU 201 grants the player a bonus according to the condition that has been determined as met in step S13. As a bonus, a credit or a right to play a free game, for example, is granted. Then, the processing continues to step S15.

In step S15, the CPU 201 determines whether the first symbol has been displayed on the display devices 102 after the scroll has been stopped in the first game. When it has been displayed (Yes), the processing continues to step S16, and when it has not been displayed (No), the processing continues to step S11.

In step S16, the CPU 201 starts executing the second game of slot game in accordance with operation instructions or the like by the player to the gaming apparatus 100. It is noted that if the first game is a normal game, the second game is a normal game, and if the first game is a free game, the second game is a free game. Then, the processing continues to step S17.

In step S17, the CPU 201 spins reels on which the second symbol is shown at predetermined intervals. In accordance with the spin, the CPU 201 displays the second symbol on the display devices 102 while sequentially scrolling to the second symbol in a predetermined timing. The CPU 201 stops the spin of the reels at a predetermined timing to stop the scroll display of the symbols. Then, the processing continues to step S18.

In step S18, the CPU 201 determines whether the locations of symbols displayed on the display devices 102 after the scroll of symbol display (the spin of the reels) has been stopped meet a condition that is set in advance for granting a bonus. This condition can comprises a condition based on the location of a predetermined symbol in the first game and the location of a predetermined symbol in the second game. Specifically, the condition can comprises a condition that the stop position of the first symbol in the first game and the stop position of the second symbol in the second game have a predetermined positional relationship (for example, being located at the same position). When the condition is met (Yes), the processing continues to step S19, and when the condition is not met (No), the processing shown in FIG. 6 ends.

In step S19, the CPU 201 grants the player a right to play a free game as a bonus, and starts the free game. Then the processing shown in FIG. 6 ends. It is noted that, before step S19, in some cases, the player has already been granted a right to successively play a free game a plurality of numbers of times (for example, ten times), and as a result, the second game is played during successive play of free games. In such a case, a right to play another free game is granted after the successive play of free games has been finished.

As described, in accordance with the present embodiment, the player is granted a bonus when the stop position of the first symbol in the first game and the stop position of the second symbol in the second game have a predetermined positional relationship.

Accordingly, a game with more fun is provided than a conventional game in which the player is granted a bonus in accordance with the positional relationship of symbols displayed when the reels have been stopped, in a single game alone. That is to say, the player hopes that, in the first game, the first symbol will be displayed after the reels have been stopped. In addition, when the first symbol has been displayed in the first game, the player hopes that, in the second game, the second symbol will be displayed after the reels have been stopped. This results in gradually raising the hope of the player for a bonus over a plurality of games. Thus a game with more fun is provided.

### Modified Example

The present disclosure is not limited to the embodiment, and can be carried out with various modifications added thereto without departing from the spirit of the present application. The embodiment is merely an example in any point, and shall not be construed in a limited manner. For example, the following modified example can be adopted.

In the embodiment, when the first symbol has been displayed on the display devices 102 after the scroll in the first game has been stopped, the reel control unit 430, in the second game succeeding the first game, has spun the reels on which the second symbol is shown and the first symbol is not included. Further, in accordance with the spin, the reel control unit 430 displays the second symbol on the display devices 102 while sequentially scrolling to the second symbol.

In a modified example of such processing, the first symbol and the second symbol may be shown on both of the reels spinning in the first game and the reels spinning in the second game. In such a case, for example, the reel control unit 430, in the second game, indicates, in an arbitrary manner, the position of the first symbol among symbols displayed on the display devices 102 when the spin of the reels is stopped in the first game (for example, in the second game, showing a symbol having a form similar to the first symbol). Then, the bonus determination unit 440 is capable of granting the player a right to play a free game as a bonus on the condition that the stop position of the first symbol in the first game and the stop position of the second symbol in the second game have a predetermined positional relationship (for example, being located in the same position).

In addition, although the bonus in the embodiment is a free game, a monetary bonus (for example, granting a credit) may be set as a bonus.

### LIST OF REFERENCE NUMERALS

100 Gaming apparatus
101 Speaker
102 Display devices
103 Operation input device
104 Card reading device
105 Paper money insertion device
106 Ticket dispensing device
201 CPU
202 Main memory
203 BIOS-ROM
204 Storage device
205 Speech processing unit
206 Image processing unit
207 Communication interface
208 Peripheral interface

1: A gaming apparatus comprising: a control unit; and a display unit,
wherein the control unit has:
a function of, in a first game, changing display of the display unit by sequentially displaying a first symbol on the display unit, and stopping the changing of display at a predetermined timing;
a function of, in a second game, changing display of the display unit by sequentially displaying a second symbol on the display unit, and stopping the changing of display at a predetermined timing, after the first symbol has been displayed at the time of the stop in the first game; and
a function of granting a bonus on a condition that a position where the first symbol is displayed at the time of the stop in the first game and a position where the second symbol is displayed at the time of the stop in the second game have a predetermined positional relationship.

2: The gaming apparatus according to claim 1, wherein the bonus is a right to play a free game.

3: The gaming apparatus according to claim 1, wherein the condition includes a condition that the position where the first symbol is displayed at the time of the stop in the first game and the position where the second symbol is displayed at the time of the stop in the second game coincide with each other.

4: The gaming apparatus according to claim 1, wherein the bonus to be granted is determined in accordance with at least a type of one of the first symbol and the second symbol that have the predetermined positional relationship.

5: The gaming apparatus according to claim 1, wherein the bonus to be granted is determined in accordance with at least a combination of the first symbol and the second symbol that have the predetermined positional relationship.

6: A game control method implemented by a computer that includes a control unit, and a display unit, the game control method causing the control unit to execute:
a step of, in a first game, changing display of the display unit by sequentially displaying a first symbol on the display unit, and stopping the changing of display at a predetermined timing;
a step of, in a second game, changing display of the display unit by sequentially displaying a second symbol on the display unit, and stopping the changing of display at a predetermined timing, after the first symbol has been displayed at the time of the stop in the first game; and
a step of granting a bonus on a condition that a position where the first symbol is displayed at the time of the stop in the first game and a position where the second symbol is displayed at the time of the stop in the second game have a predetermined positional relationship.
